(19) United States
(12) Patent Application Publication
(10) Pub. No.: US 2009/0263517 A1
(43) Pub. Date: Oct. 22, 2009

(54) METHOD FOR PRODUCING MARGOSA EXTRACT

(75) Inventor: Heinz Rembold, Munchen (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: TERRA NOSTRA PRODUKTE MIT NATUREXTRAKTEN GMBH, Geisenfeld (DE)

(21) Appl. No.: 11/916,833

(22) PCT Filed: Jun. 8, 2006
(86) PCT No.: PCT/EP06/05505

§ 371 Date: May 16, 2008

(30) Foreign Application Priority Data
Jun. 8, 2005 (DE) 10 2005 026 424.7

(51) Int. Cl. A01N 65/26; C11B 1/10; A01P 7/00

(52) U.S. Cl. 424/761; 554/11; 554/8

(57) ABSTRACT

The invention relates to a method for producing a margosa extract, an oil from cores and/or seeds of the neem tree being used and the oil being extracted using a carbon dioxide-containing extracting agent. The invention further relates to a margosa extract as is obtained using the method, its use as an agent for pest control and a composition for pest control which contains this extract.

The invention relates to a method for producing a margosa extract, a margosa extract as is obtained using the method according to the invention, the use of this margosa extract and a pesticide which contains the margosa extract.

The neem tree (Azadirachta indica) and particularly its seeds have recently been moved to the field of pest control in scientific interest. The manifold possibilities for the use of the tree belonging to the mahogany tree family, growing approximately 15 meters high and yielding up to 100 kg of fruit are described in detail in H. Schmutterer, The Neem Tree, Neem Foundation, Mumbai 2002, 2nd Edition. The neem oil obtained from neem seeds is recorded in the EU with the CAS number 11141-17-6 and as margosa extract under the provisional notification number [N621].

The neem tree and its constituents are a confirmed constituent of Indian natural medicine. Ground neem nuts, neem oil pressed from neem nuts and the press cakes remaining behind during pressing are used as starting substances for producing relatively high-grade products, such as soaps or toothpastes or even directly as medicaments. In order also to be able to apply this knowledge, however, for the use of consumers in the industrial countries, the products must be suited to the demands of the consumers. Thus products which are obtained by expressing the neem seeds, that is the neem oil and the press cakes, contain compounds which on admittance of air cause a garlic-like odor. Further, the products obtained from constituents of the neem tree have a dark brown coloration, which on relatively long storage, in particular with admission of air, becomes even more intense. Bleaching is only possible for applications in which the medicinal action of the components of the neem seed is not of importance, for example in producing soaps. If, however, advantageous effects of the neem seed are utilized which are attributed to sensitive components of the neem seed, for example azadirachtin, bleaching is only possible under extremely mild conditions which do not lead to destruction of the components.

In WO 97/25867, a method for the extraction of components from constituents of the neem tree, preferably from seeds and nuts, is described. The extracting agent used is carbon dioxide in the subcritical or supercritical state, the extracting agent being recycled. In the course of this, the ground neem seeds or a press cake obtained by expressing the neem seeds for the partial removal of the oily constituents is used. The extract shows outstanding properties as a pest control agent, in particular as a repellent against the house dust mite.

In a comparative study (Allergo J. 2004, 13: 269-73), H. Rembold and H. Oetzel demonstrate that formulations based on neem oil obtained by CO₂ extraction are up to a hundred times more active against the house dust mite, Dermatophagoides farinae, in their destruptive action towards mite growth in comparison with the products produced based on press oil.

Attempts to carry out the extraction of the neem seeds with carbon dioxide directly at the site of the producers in India have failed up to now. In spite of extensive efforts, it was not possible to ensure a constant quality of the extract. We are therefore still forced to import the neem seeds from the producer country to an industrial country, such as Germany, in order to then extract the ground neem seeds there with carbon dioxide. Only in this way was it possible to achieve a constant quality of the extract. In the case of the extracts produced in Germany, however, time and again batches were obtained which have an unpermissibly high content of aflatoxins and therefore had to be discarded.

The obtainment of active substances from the natural material is often preceded by a lead time for collection and drying, transport, and finally in storage on site until final processing. At relatively high temperatures and relatively high humidity, and especially also without, often undesirable, use of fungicides, the danger of fungal growth in oil-containing material is particularly high, which can then lead to the contamination of the goods with mycotoxins. The cancer-producing aflatoxins are a particular danger here.

Fungi, especially the carcinogenic aflatoxin-producing Aspergillus flavus, are a risk which is difficult to calculate in the processing of oil-containing seeds and thus also of neem seeds. The neem tree grows only in a tropical, moist and warm climate. The fruit must therefore be freed from the fruit flesh immediately after harvesting and the nuts dried in the shade in order to avoid a decrease in the biologically active substances. Only at a water content of approximately 15% can the nuts be shipped in containers which, if they are not air-conditioned, are exposed to greatly varying temperatures during sea transport. There is then, even in the case of a previously fungally uninfected material, the danger of moist niches favoring fungal growth forming, which even in the case of later competent visual checking cannot unconditionally be detected. Visual checking is carried out by removing seeds from a certain number of the sacks delivered and by inspection for fungal infection. Here, however, nuts can be removed in each case only from a limited number of sacks and in the case of the selected sacks only from a certain position in the sack. Checking of all nuts delivered is therefore not possible. Whether aflatoxins happen to be contained in a material subdivided into manageable sacks can therefore often only be clearly determined after work-up, that is in the finished extract.

The extract obtained by extraction with carbon dioxide is successfully employed as a repellent against the house dust mite. This especially takes up residence in mattresses and bed linen. Its feces exhibit a strongly allergenic effect. The syndrome is also described as house dust allergy. By applying the neem extract in a suitable formulation to mattresses and bed linen, a significant reduction of the house dust mite population and thus of the allergenic contamination can be achieved. Since the extract, however, can come into contact extensively with humans by means, for example, of the bed linen, it must be ensured that the extract is not contaminated with mycotoxins, in particular aflatoxins. On the other hand, the consumers place great value on a purely biological origin of the extract, so that synthetic preservatives also cannot be used in order to protect the seeds from fungal attack during transport.

The invention was therefore based on the object of making available a method for producing a margosa extract, which leads to an extract which has at least the same activity as an extract obtained from neem seeds or press cakes according to processes known up to now, the danger of contamination of the extract with mycotoxins, in particular aflatoxins, being largely excluded.

This object is achieved by a method having the features of patent claim 1. Advantageous refinements of the method are the subject of the dependent claims.

In the method according to the invention, the extract is obtained by extraction of an oil with carbon dioxide, it being possible to obtain the oil from neem seeds by pressing. This has the advantage that samples can be removed from the combined oil of a batch in order to be checked for contamination by aflatoxins. The aflatoxin content of an entire batch can thus be checked using a single measurement and not only individual nuts in a spot check-like fashion. It can thereby be ensured that the extract is not contaminated with mycotoxins even before the extraction of the oil obtained by cold pressing of neem nuts or neem seeds. Furthermore, the oil needs a significantly smaller volume for its transport in comparison to the nuts, so the transport costs fall. The oil is also significantly less sensitive to attack by fungi than is the case with the neem nuts. The transport risk thereby also falls. Furthermore, the expressing can also be carried out reliably in the country of origin of the neem nuts or seeds, such that on the one hand the production of the extract can be significantly reduced in price and on the other hand a further member of the value creation chain remains in the country of origin of the neem nuts, whereby jobs result or can at least be secured.

Extraction with supercritical carbon dioxide is the greatest cost factor in the obtainment of the oil. Using the method shown here, a way is presented which makes possible the obtainment of mycotoxin-free and at the same time biologically highly active neem oil, the “margosa extract”, from an oil not contaminated with mycotoxins.

Surprisingly, it has been shown that from the neem oil obtained by pressing neem seeds or cores, an extract can also be obtained which has an at least equally high activity as an extract which is obtained by direct extraction of the seeds or of the press cake. As was shown in the abovementioned article of Rembold and Oetzel, an extract which was obtained directly from neem seeds by extraction with carbon dioxide has a markedly higher activity than the press oil. While using samples which contained press oil, it was possible to lower the number of living mites to 576 and 533 respectively in a long-term experiment, it was possible using preparations which contained an extract which was obtained by extraction of the neem seeds with carbon dioxide to lower the number of mites to 126 and 28 respectively. The number of mites in a control experiment in which no neem extract had been employed was 3550. Up to now, it has been started out from the fact that a high active substance content can only be obtained when the extraction takes place directly from the ground seeds or the press cake. It is assumed that in the case of the extraction of the press oil with carbon dioxide, the substances accumulate in the residue, which does not prevent, but rather increases, the growth of house dust mites. The refined neem oil, however, has a stronger damaging influence on the mite growth than the starting material. In the method according to the invention, presumably substances of the type which decrease the action of the neem oil on the mites are thus separated off.

The press oil used as a starting material can be obtained from the neem seeds or cores by pressing in customary oil mills. The neem seeds or cores are preferably cold-pressed.

In the subsequent extraction of the press oil with carbon dioxide, a clear yellow oil is obtained in high yield, which is virtually odor-free and even on relatively long storage in air does not develop a rancid odor.

For simpler extraction, the press oil is preferably applied to an inert carrier. This can be carried out, for example, by mixing the oil with the carrier, the amount of the carrier preferably being chosen such that a free-flowing powder is obtained. The carriers used are preferably inorganic carriers. After extraction, the carrier coated with residues can be further used, for example, as a fertilizer or as a feed additive. The carrier is therefore preferably present in powder form. Suitable inorganic materials are, for example, kieselguhr and silica gel. However, a more coarsely particulate material can also be employed, such as, for example, clay granules or ground pumice. The ratio of carrier material and press oil is preferably chosen such that, as already mentioned, a free-flowing powder is obtained which has a content of oil which is as high as possible. The ratio of carrier to oil is preferably chosen in the range from 3:1 to 1:2, preferably 2:1 to 1:1.

The extraction of the oil is carried out in customary extraction units. The extraction conditions are preferably chosen such that the carbon dioxide extraction is carried out at a pressure of 250 to 600 bar, preferably 300 to 400 bar.

Furthermore, the extraction is preferably carried out at a temperature between 30 and 70° C., preferably between 30 and 45° C. At this temperature, the carbon dioxide has a good extracting action, in particular for azadirachtins. In addition, the extraction can be carried out so gently at these temperatures that no loss in activity of the extract has to be accepted.

The extracting agent is particularly preferably recycled.

Comparatively small amounts of carbon dioxide are therefore necessary for the extraction. In the method according to the invention, very high yields are obtained. The interfering substances remain in the extraction vessel, for example bound to the inert carrier. Even in the case of a relatively long extraction period, for example with relatively large batches, no impairment of the activity of the extract is observed, i.e. the interfering substances remain firmly bound to the inert carrier and are not carried off in the extract by the recycled carbon dioxide. Preferably, however, the extraction is carried out in such a manner that the extraction is terminated when 90-95% of the neem oil employed is present as an extract in the receiver. In the remaining 5% of the oil employed from cores and/or seeds of the neem tree, more poorly soluble interfering components, such as colorants, oxidized oil constituents and other undesired components are present in enriched form, but virtually no active components. It is thereby possible to further increase the purity and thus the quality of the margosa extract obtained.

The extracting agent is preferably depressurized at a temperature of 10 to 80° C., preferably 25 to 40° C., to a pressure of 30 to 80 bar, preferably 50 to 70 bar. In this way, thermal stress of the substances contained in the extract is avoided, which could lead to decomposition and thus a loss in activity.

An entraining agent can be added to the extracting agent, essentially carbon dioxide. The entraining agent preferably has a higher polarity than carbon dioxide. Suitable entraining agents are preferably selected from the group consisting of alcohols, ketones, esters, nitrites or cyclic ethers. In particular, in order to make possible easy removal of the entraining agent after the extraction, entraining agents are preferably used which have a carbon number of between 1 and 5. The entraining agents then have a sufficiently low boiling point, such that they can be easily removed from the extract under reduced pressure.

The proportion of the entraining agent in the extracting agent is preferably 0.5 to 30%, particularly preferably 2 to 10%.

The extraction is preferably carried out using pure carbon dioxide.

The extraction of the press oil can be carried out fractionally. A separation of interfering limonoids can thereby optionally be achieved. The fractionation of the press oil can take place by, for example, carrying out the extraction at different pressures; the pressure during the extraction is thus increased, for example, stepwise. Fractionation can also be achieved in that the concentration of an entraining agent added is altered, for example is increased stepwise. A fractionation of this type is useful, for example, in order to obtain fractions having a high azadirachtin content. In the method according to the invention, however, fractionation is only necessary in exceptional cases. By pressing off, a considerable proportion of the interfering substances appears to remain in the press cake, such that special fractionation methods are not necessary per se.

The duration of the extraction process depends on the batch size and can be easily determined by the person skilled in the art by, for example, measuring the amount of the extract per time unit. This is possible very simply by replacing the previously weighed receiver regularly and determining the amount of the extract collected in the receiver by differential weighing. Customarily, an extraction period of approximately 2 to 9 hours, preferably 3 to 6 hours, is needed for the extraction of 100 kg of press oil.

Using the extraction method according to the invention, a margosa extract is obtained which is a pale yellow oil and which, for example, shows a very high repellent action against the house dust mite. The invention therefore also relates to a margosa extract as can be obtained using the method described above. The margosa extract according to the invention is distinguished by characteristic features in the UV spectrum and in the relative intensities of a gas chromatogram.

The margosa extract according to the invention shows a very good action as a pest control agent. The invention therefore also relates to the use of the margosa extract described above as a pesticide. A particularly good action is observed when the margosa extract is used as a repellent for house dust mites. The margosa extract does not act here as an acaricide, thus does not directly kill the mites. Rather, the action of the extract appears to consist in denying the mites food intake, that is starving them. The amount of excreted mite feces is therefore also decreased and thus the amount of the allergen which is contained, for example, in a mattress or a duvet. The action of the margosa extract on the house dust mite can therefore be quantified directly by its feces excretion.

The invention further relates to a pesticide which comprises the margosa extract described above. For this, for example, the extract can be taken up in a suitable solvent, for example an alcohol or alcohol/water mixture. If alcohol/water mixtures are used, the water content is preferably chosen to be less than 30% by weight. Comparatively low concentrations of the extract in the pesticide are necessary here. Suitably, the concentration of the margosa extract in the solvent is chosen to be in a range from 0.1 to 10% by weight, preferably 0.5 to 5% by weight, particularly preferably 0.6 to 1% by weight. The extract can thereby be distributed in very dilute form, for example, on a mattress or in a filling of a mattress or of a duvet.

The invention is illustrated in detail below with reference to the attached figures. These show:

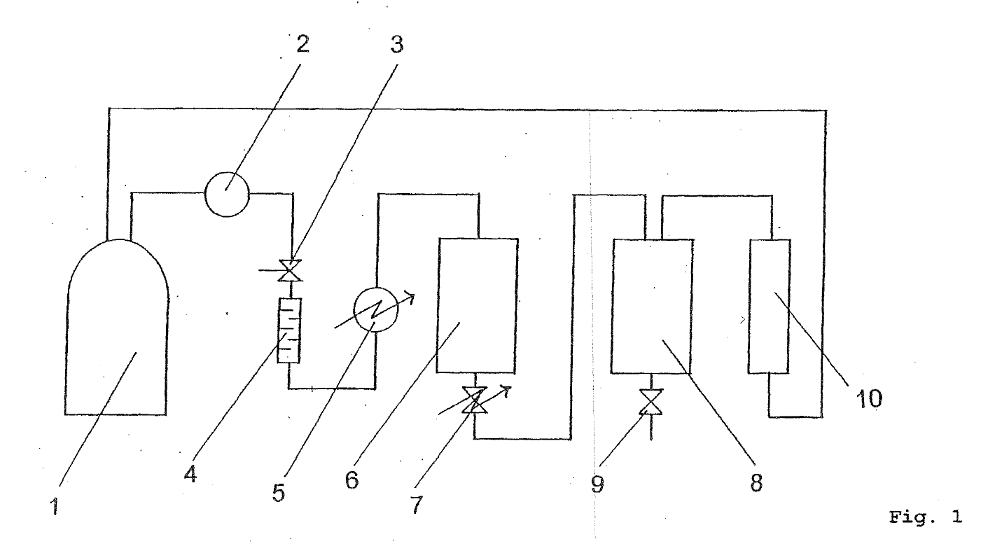

FIG. 1: A schematic representation of the apparatus for carrying out the method according to the invention;

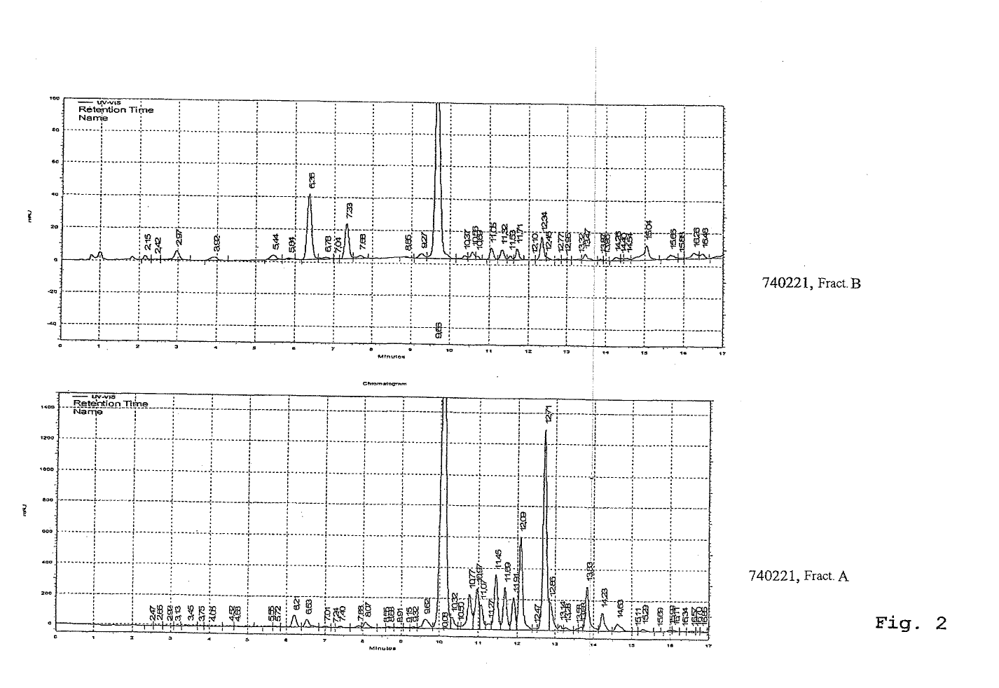

FIG. 2: an HPLC chart of fractions A and B;

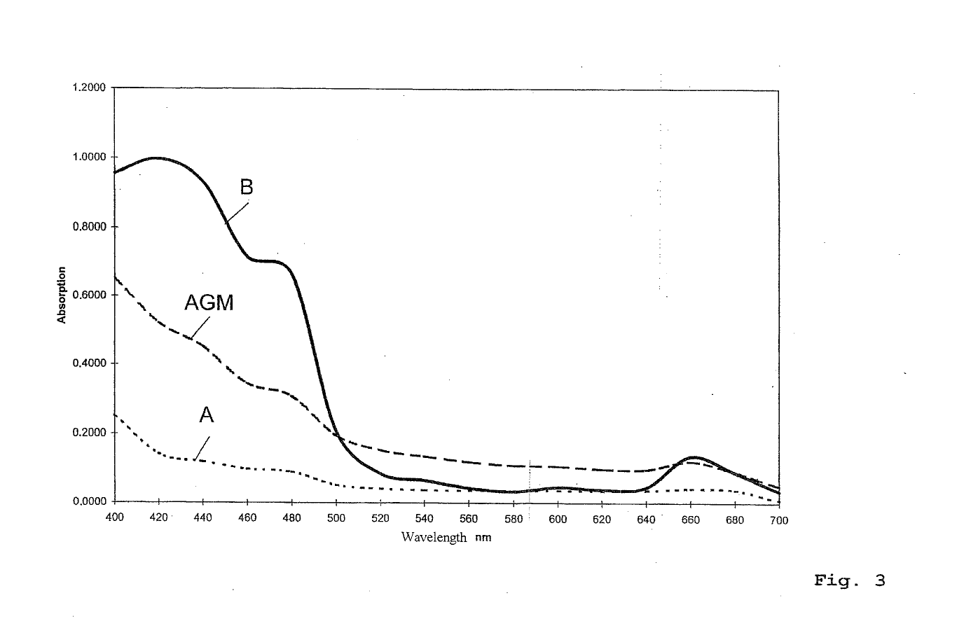

FIG. 3: a UV spectrum of the press oil used as a starting material and of the extracted fractions A and B;

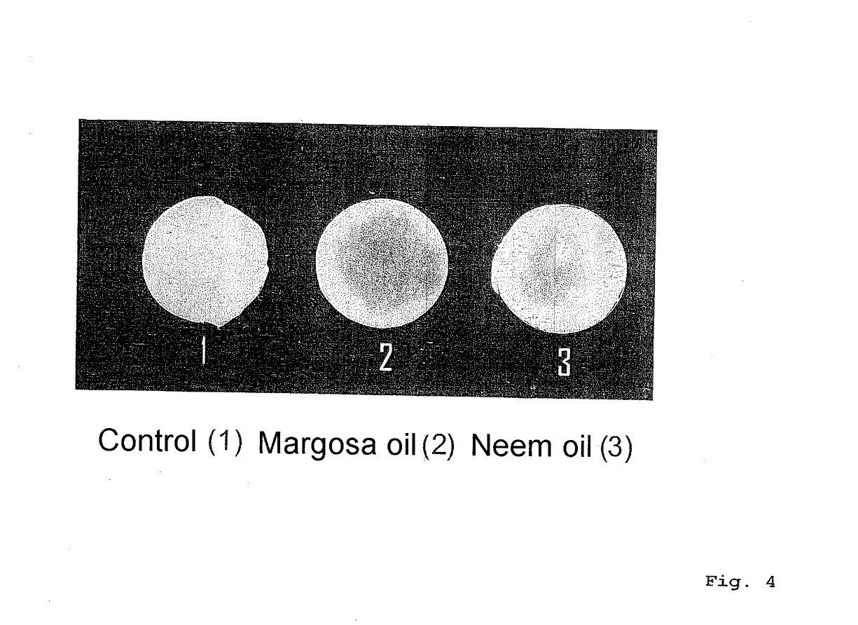

FIG. 4: an illustration of the test sheets on which mite feces are deposited.

FIG. 1 illustrates schematically a unit which is suitable for carrying out the method according to the invention. CO₂ is removed from a reservoir 1 and brought to the necessary pressure by means of a compressor 2 or a pump. By means of an injection site 3, entraining agent can optionally be added, which is mixed with the carbon dioxide by means of a mixing stretch 4. In a heat exchanger 5, the extracting agent is brought to the desired temperature and subsequently fed to an extraction chamber 6, where the subcritical or supercritical state is maintained. The extraction chamber is filled with an inorganic carrier, such as kieselguhr, to which the press oil to be extracted is applied. After the extraction, the carbon dioxide-containing extract is led through a heatable pressure reducer valve 7 to lower the pressure and then led into a separating chamber 8, where extract and optionally entraining agent are separated from the carbon dioxide. The extract can be removed from the separating chamber 8 at the removal position 9. Subsequently, the carbon dioxide is cooled in a cooler 10. The liquefied gas is fed again to the reservoir 1.

### EXAMPLE 1

### Production of the Margosa Extract

5 kg of cold-pressed oil obtained from neem cores are mixed with 10 kg of kieselguhr (mixing ratio 1:2) until a homogeneous mixture is obtained which is capable of flow. The press oil used as a starting material (SM) was a cloudy, golden oil. The mixture is filled into the extraction container of an extraction device for carbon dioxide and then extracted for 5 hours at 300 bar and 50° C. (pressure and temperature measured at the entrance of the extraction vessel). Subsequently, the receiver was changed (fraction A) and 3% ethanol was added to the carbon dioxide as an entraining agent and the mixture was extracted for a further hour. The extract was collected in a receiver (fraction B). The alcohol contained in the extract of fraction B was distilled off in vacuo with the aid of a rotary evaporator and discarded.

TABLE 1
Yields in the carbon dioxide extraction of 5 kg of neem oil

| | | |
|---|---|---|
| Yield: | Fraction A | 4.73 kg (94.6%) |
| | (clear yellow oil) | |
| | Fraction B | 0.27 kg (5.4%) |
| | (clear brown oil) | |

Fraction B very rapidly becomes solid and presumably contains long-chain triglycerides.

Fractions A and B and the starting material were investigated by HPLC. The chromatograms of fractions A and B are shown in FIG. 2. The contents of azadirachtin A+B, nimbin and salannin were determined from the HPLC chromatograms.

TABLE 2
Content of azadirachtins, nimbin and salannin

| | % aza A + B | % nimbin | % salannin |
|---|---|---|---|
| Starting material | 0.22 | 0.28 | 0.78 |
| SM (100%) | | | |
| Fraction A | 0.24 | 0.27 | 0.74 |
| (94.7%) | | | |
| Fraction B (5.3%) | 0.0077 | 0.0027 | 0.0068 |

As the values of Table 2 show, using a solid mineral carrier the extraction process used does not change the composition of the biologically active limonoids present in the starting material (fraction A). Only traces of these compounds can be detected in the residue (fraction B). Only 5.3% of the starting material remains in the residue, which contains strongly UV-absorbing components (see FIG. 3).

For the differentiation of the various extracts of press oil from neem seeds, CO₂ margosa extract (fraction A) and margosa re-extract obtained by use of an entraining agent (fraction B) physical parameters suggest themselves. On the one hand, an extract-typical HPLC chromatogram allows the comparison of the intensity of various substances. The quotient for the retention times of 10.02/12.67 minutes is significantly different, for example, for each of the three extracts. The internal marker used for checking the retention times was the commercially obtainable salannin. In a corresponding manner, different intensities of the respective UV absorption spectra show significant differences depending on wavelength (as an example see Table 3, FIGS. 2 and 3).

TABLE 3
Quotients for retention times and UV absorption of various extracts

| Quotient | 10.02/12.67 min | 480/660 nm |
|---|---|---|
| Press oil from neem | 0.16 | 2.86 |
| seed extract | | |
| Margosa extract | 2.92 | 2.34 |
| (fraction A) | | |
| Margosa re-extract | 12.52 | 5.32 |
| (residual oil, | | |
| fraction B) | | |

### EXAMPLE 2

### Biological Action

### a) Mite Breeding:

For the tests, a mixed culture of three breeding batches of Dermatophagoides farinae was used. The mites were raised in special vessels on a protein- and starch-containing feed in a desiccator at room temperature and at 80% relative humidity for 30 days. Mites and mite eggs from this batch were employed in the test samples.

### b) Test System

The test method was carried out following the ISO guidelines AFNOR NF G39-011. In climatic cabinets developed in-house of 0.055 m³ content with transparent outer sides a humidity of 65-80 rF continuously starting up and shutting down was adjusted by means of an aqueous sodium chloride solution. The temperature was kept at 24° C. with the aid of metal surface heating. The constancy of these conditions was controlled by air circulation and by means of sensors, which regulated overshooting humidity and temperature values by supply of fresh air under computer control. The constancy of temperature and humidity was recorded during the entire experimental period.

Glass petri dishes of 7 cm diameter and having a special cover made of light metal were used, which, provided with a rubber sealing ring, sealed the glass dish air-tight. For the aeration of the samples, the cover has a round opening of 3 cm diameter in the center, which is sealed with an aeration membrane made of polytetrafluoroethylene (PTFE). As a substrate for the mites, a mixture of mite-free house dust and about 0.25 g of feed was added per dish. In each case, approximately 200 mites and 50 eggs were introduced into the dishes. At most 18 samples were set up per climatic cabinet.

The various test substances were sprayed as uniformly as possible into the prepared vessels preincubated with feed and mites for 12 hours in an amount of in each case 20 ml/m². Four to six dishes of each sample and likewise six dishes of the isopropyl alcohol control were set up. For the checking of the feces and allergen production, in the cover of each dish a round adhesive disc of plastic (thickness 0.01 mm, diameter 3 cm) was stuck on with the aid of an adhesive strip such that it touched the bottom and the mites were able to run over it. After evaporation of the alcohol, the experimental vessels were placed in the climatic cabinet and checked weekly for mortality and change in the behavior of the mites.

The experiment was ended after 14 weeks. The length of the experimental period also allows a statement about the action of the test substances on the fertility of the eggs. In the weekly checks, it was in no case found that all experimental animals had died.

The following samples were used as test substances:

| | | |
|---|---|---|
| Control | (1) | Isopropanol |
| Margosa oil | (2) | Extract from neem oil, obtained in Example 1 |
| Neem oil | (3) | Extract from neem seeds, prepared according to |
| | | WO 97/25867, obtained by direct extraction of |
| | | ground neem nuts with CO₂ |

In FIG. 4 are illustrated the round adhesive strips of plastic which were positioned in the test vessels in the test procedure described above. The adhesive strips are originally transparent and are laid on a black background for the demonstration. The mite feces correspond to the white areas, whereas in sections which are not or only slightly covered by mite feces appear dark, since the black background remains visible through the transparent adhesive discs. The extent of the light areas reflects the size of the mite population, since a large mite population also produces large amounts of mite feces. The greater the dark areas are absent, the smaller the mite population.

In the case of the control (1), a thick white layer of mite feces has been deposited on the adhesive disc. The black background is thickly covered by the mite feces. The growth of the mites is not inhibited.

In the margosa extract according to the invention (2), only at the edge of the adhesive disc can white areas be seen, which indicate covering with mite feces, while the inner section of the adhesive disc is largely uncovered by mite feces and therefore appears dark.

In the extract of neem seeds (3) which was obtained by direct extraction of the ground neem seeds with carbon dioxide, a wider white edge can be seen. In the center of the adhesive disc, however, the dark background shows through, so that even with this extract a clear inhibition of the growth of the mite population is observed, even if not to an extent as is achieved with the margosa extract. The amount of feces, however, is markedly lower than in the case of the control (1).

By means of the margosa extract (2) and also by means of the extract of neem seeds it is achieved that the mites largely deny food intake and finally starve without reproducing beforehand. The mite population and thus also the mite allergen contained in the feces therefore decrease continually with time. Compared to the extract of neem seeds, the action in the case of the margosa extract according to the invention, however, is again markedly increased.

1. A method for producing a margosa extract, comprising
removing oil from cores and/or seeds of the neem tree, and
extracting the margosa extract from the oil using a carbon dioxide-containing extracting agent.

2. The method as claimed in claim 1 wherein the oil is obtained by expressing the cores and/or seeds of the neem tree.

3. The method as claimed in claim 1 wherein the oil is applied to an inert carrier.

4. The method as claimed in claim 3 wherein the carrier employed is a pulverulent inorganic material.

5. The method as claimed in claim 3 wherein the inert carrier is selected from kieselguhr and silica gel.

6. The method as claimed in claim 1 wherein the extraction is carried out at a pressure of 250 to 600 bar.

7. The method as claimed in claim 1 wherein the extraction is carried out at a temperature in the range from 10 to 70° C.

8. The method as claimed in claim 1 wherein the extracting agent is recycled.

9. The method as claimed in claim 1 wherein the extracting agent is depressurized at a temperature of 10 to 80° C., to a pressure of 30 to 80 bar.

10. The method as claimed in claim 1 wherein the extracting agent contains a proportion of an entraining agent.

11. The method as claimed in claim 1 wherein the extraction is carried out fractionally.

12. (canceled)

13. (canceled)

14. A process for repelling house dust mites comprising applying the margosa extract produced by the process of claim 1 to a household linen product.

15. A pesticide comprising the margosa extract prepared by the process of claim 1.
